(19) United States
(12) Patent Application Publication
(10) Pub. No.: US 2026/0056535 A1
(43) Pub. Date: Feb. 26, 2026

(54) BATTERY SERVICING SYSTEM FOR USE IN BATTERY SERVICING STATION AND METHOD THEREOF

(71) Applicant: AUTOCRAFT EV SOLUTIONS LIMITED, Belton (GB)

(72) Inventors: Daniel Kitchin, Belton (GB); Simon Warburton, Belton (GB)

(73) Assignee: AUTOCRAFT EV SOLUTIONS LIMITED, Belton (GB)

(21) Appl. No.: 18/997,482

(22) PCT Filed: Jul. 20, 2023
(86) PCT No.: PCT/GB2023/051910

§ 371 Date: Jan. 21, 2025

(30) Foreign Application Priority Data
Jul. 22, 2022 (GB) 2210752.8

(51) Int. Cl. G05B 19/418

(52) U.S. Cl. CPC G05B 19/41875; G05B 2219/32368

(57) ABSTRACT

A battery servicing system for use in a battery servicing station, includes a plurality of actuators and a controller configured to control the plurality of actuators to position a battery being tested on a lid that is configured as a test plate on a workstation in the battery servicing station. The controller is configured to test the battery based on a predefined set of reference parameters and automatically eject the battery from the battery servicing station when the battery is determined to be malfunctioning. The controller is configured to drop a container part onto the malfunctioning battery such that the lid and the container part are gaged along with the malfunctioning battery and transport away from the battery servicing station. The battery servicing system improves the safety of disposal of a malfunctioned battery by enabling an efficient and fail-safe automatic ejection of the malfunctioned battery outside the battery servicing station.

### TECHNICAL FIELD

The present disclosure relates generally to the field of electric vehicles and battery servicing systems; and more specifically, to a battery servicing system for use in a battery servicing station and a method for servicing a battery (e.g., an electric vehicle battery pack).

### BACKGROUND

Generally, at an electric vehicle service station, a number of electric vehicle (EV) batteries are manufactured, processed, and tested for use in electric vehicles, hybrid electric vehicles, plug-in hybrid electric vehicles, and the like. However, the testing is mostly limited to prototype testing or testing of newly manufactured batteries. In certain scenarios, for example, after prolonged use, some EV batteries may develop some defects and may not function properly. Such defective EV batteries are currently required to be transported to a dealer or a dedicated service station, where they are usually discarded. Transportation and handling of such defective EV batteries is a huge industry-wide problem as they are classified as dangerous goods.

Currently, the defective EV batteries are transported, for example, by use of forklifting or other known lifting methods (that are again human assisted). However, existing lifting methods involve a potentially hazardous movement of the defective EV batteries as it requires human intervention and dropping a large and heavy EV battery at a safe location. Thus, there exists a technical problem of how to develop a holistic testing process that is valid for not only developing new EV batteries but also effective for used EV batteries and further how to ensure safe transportation of the defective EV batteries that may be hazardous to the electric vehicle service station and the human life as well.

Therefore, in light of the foregoing discussion, there exists a need to overcome the aforementioned drawbacks associated with the conventional methods of transporting the defective EV batteries.

### SUMMARY

The present disclosure provides a battery servicing system for use in a battery servicing station and a method for servicing a battery. The present disclosure provides a solution to the existing problem of how to develop a holistic testing process that is valid for not only developing new EV batteries but also effective for used EV battery and further how to ensure safe transportation of the defective EV batteries that may be hazardous to the electric vehicle service station and the human life as well. An aim of the present disclosure is to provide a solution that overcomes at least partially the problems encountered in prior art and provide an improved battery servicing system for use in a battery servicing station and an improved method for servicing a battery.

One or more objects of the present disclosure is achieved by the solutions provided in the enclosed independent claims. Advantageous implementations of the present disclosure are further defined in the dependent claims.

According to an aspect of the present disclosure, there is provided a battery servicing system for use in a battery servicing station. The battery servicing system comprises a plurality of actuators and a controller configured to control the plurality of actuators to position a battery being tested on a lid that is configured as a test plate on a workstation in the battery servicing station. The controller is further configured to test the battery based on a predefined set of reference parameters and automatically eject the battery from the battery servicing station when the battery is determined to be malfunctioning. The controller is further configured to drop a container part onto the malfunctioning battery such that the lid and the container part are engaged along with the malfunctioning battery and transported away from the battery servicing station.

The battery servicing system is flexible and universal in use (i.e., suitable to perform tests on all types of EV batteries irrespective of their manufacturers or product type and even effective to perform tests on used EV batteries). The battery servicing system solves the problem of hazardous transportation of the malfunctioned batteries. The battery servicing system ensures safety in operations while performing tests on the battery as well as facilitating safe ejection outside the battery servicing system. The battery servicing system enables an automated ejection of the malfunctioned battery and transports the malfunctioned battery outside the battery servicing station. Due to automatic ejection of the malfunctioned battery outside the battery servicing station, no conventional lifting equipment and human intervention is required at least for transportation of the malfunctioned battery (e.g., safety ensured in discarding of used EV battery that is tested as defective).

In an implementation form, the ejection of the malfunctioning battery comprises sensing a placement and an orientation of the malfunctioning battery with respect to an opening of the container part and where the container pair when engaged with the lid constitute an isolation unit for containment of the malfunctioning battery.

By virtue of sensing the placement and the orientation of the malfunctioning battery with respect to the opening of the container part, a more accurate ejection of the malfunctioning battery outside the battery servicing station can be obtained.

In a further implementation form, the ejection of the malfunctioning battery further comprises generating an alert for an operator present in the battery servicing station when the battery being tested is determined to be malfunctioning.

The generation of the alert for the operator on determination of the malfunctioning battery leads to a fast response and supports a safe evacuation of operators from the battery servicing station.

In a further implementation form, the ejection of the malfunctioning battery is automatically performed on completion of a defined threshold time when an input is not detected from the operator within the defined threshold time.

The automatic ejection of the malfunctioning battery on completion of the defined threshold time avoids any damage to the battery servicing station as well as any harm to the operators working at the battery servicing station.

In a further implementation form, the ejection of the malfunctioning battery further comprises disconnecting one or more physical connections from the battery in the battery servicing station, where the one or more physical connections comprises one or more of: a power cord plugged into the battery being tested, one or more fluid connections with the battery being tested, and one or more other connections for sensing a defined set of battery parameters of the battery being tested.

The disconnection of the one or more physical connections from the battery (i.e., a malfunctioning battery) in the battery servicing station ensures the safety of operators at the battery servicing station and avoids the risks of any damage to the battery servicing station.

In a further implementation form, the defined set of battery parameters of the battery comprises: voltage and current parameters, an amount of heat generated while being charged, a fluid leakage, a charge-discharge rate, and a status of health (SoH) parameters.

In a further implementation form, the battery servicing system further comprises a frame coupled with an electronic winch, where the container part is disposed outside the battery servicing station via the frame coupled with the electronic winch.

By virtue of disposing the container part outside the battery servicing station, no lifting equipment and any assistance from outside the battery servicing station is required.

In a further implementation form, one or more actuators of the plurality of actuators are provided in the workstation in the battery servicing station, and where the ejection of the malfunctioning battery further comprises moving the workstation carrying the malfunctioning battery over a defined track outside the battery servicing station by controlling the one or more actuators.

In a further implementation form, the ejection of the malfunctioning battery further comprises orientating the workstation to trigger a movement of the malfunctioning battery such that the malfunctioning battery is contained in the container part.

The orientation of the workstation leads to an automated ejection of the malfunctioning battery outside the battery servicing station.

In a further implementation form, the battery servicing system further comprises an off-grid energy storage system, where operations of the battery servicing system are powered by the off-grid energy storage system or automatically switched to the off-grid energy storage system from a mains supply in an event of a power disruption.

The use of the off-grid energy storage system enables a seamless operation of the battery servicing system even in case of the power disruption.

In a further implementation form, the battery servicing system further comprises a plurality of sensors, and where the controller is further configured to perform battery triage and repair by use of the plurality of sensors and the plurality of actuators at the battery servicing system.

By virtue of using the plurality of sensors, the battery may be repaired, reused, remanufactured or recycled after recovery depending on state of health (SoH) parameters of the battery.

In a further implementation form, the battery servicing station is an off-grid mobile electric vehicle battery servicing station arranged in a stationed vehicle, and where the container part is arranged outside the vehicle.

The use of the battery servicing station as the off-grid mobile electric vehicle battery servicing station arranged in the vehicle enables a more flexible solution for processing of EV batteries.

In another aspect, the present disclosure provides a method for servicing a battery. The method comprises controlling a plurality of actuators in a battery servicing station to position a battery being tested on a lid configured as a test plate on a workstation in a battery servicing station. The method further comprises testing the battery based on a predefined set of reference parameters and automatically ejecting the battery from the battery servicing station when the battery is determined to be malfunctioning. The method further comprises dropping a container part onto the malfunctioning battery such that the lid and the container part are engaged along with the malfunctioning battery and transported away from the battery servicing station.

The battery servicing method achieves all the advantages and effects of the battery servicing system after execution.

It is to be appreciated that all the aforementioned implementation forms can be combined.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1A is a block diagram that illustrates a battery servicing station comprising a battery servicing system, in accordance with an embodiment of the present disclosure;

FIG. 1B is a block diagram that illustrates various exemplary components of a battery servicing system, in accordance with an embodiment of the present disclosure;

FIG. 2 illustrates movement of a battery into a container part at a battery servicing station, in accordance with an embodiment of the present disclosure;

FIG. 3A illustrates an arrangement of a workstation and a container part of a battery servicing system at a battery servicing station, in accordance with an embodiment of the present disclosure;

FIG. 3B illustrates an arrangement of a container part of a battery servicing system at a battery servicing station, in accordance with an embodiment of the present disclosure;

FIG. 3C illustrates an arrangement of a workstation and a container part of a battery servicing system outside a battery servicing station, in accordance with an embodiment of the present disclosure;

FIG. 3D illustrates dropping of a container part onto a malfunctioning battery outside a battery servicing station, in accordance with another embodiment of the present disclosure;

FIG. 3E illustrates movement of a container part along with a malfunctioning battery outside a battery servicing station, in accordance with an embodiment of the present disclosure; and

FIG. 4 is a flowchart of a method for servicing a battery, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

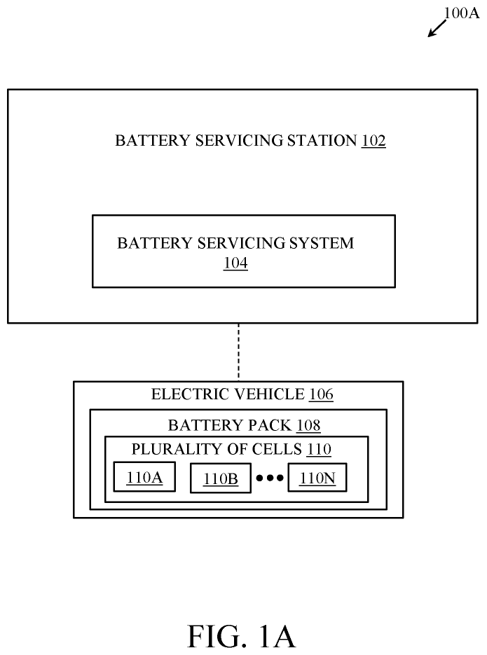

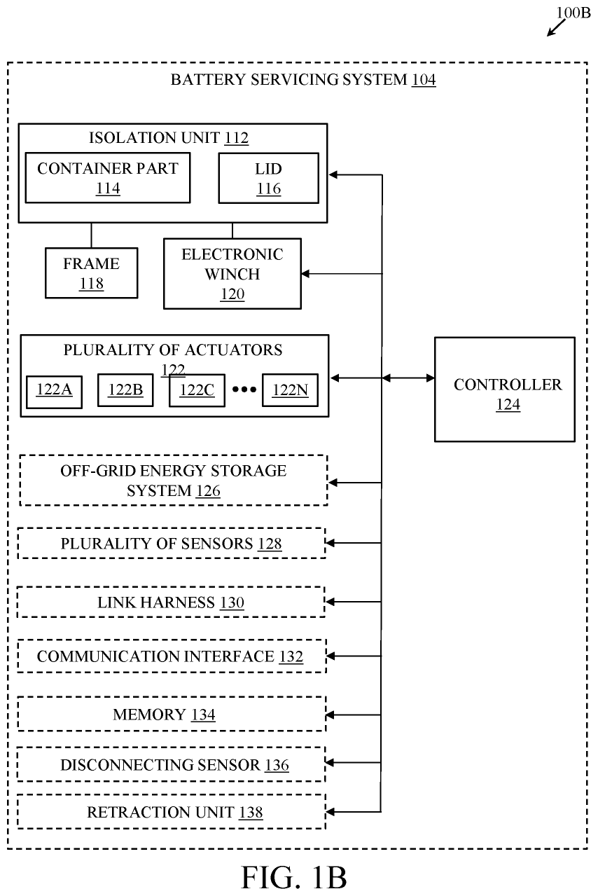

FIG. 1A is an environment diagram that illustrates a battery servicing station comprising a battery servicing system, in accordance with an embodiment of the present disclosure. With reference to FIG. 1A, there is shown an environment diagram 100A that illustrates a battery servicing station 102 comprising a battery servicing system 104. There is further shown an electric vehicle 106 comprising a battery pack 108. The battery pack 108 comprises a plurality of cells 110, such as a first cell 110A, a second cell 110B, and up to a Nth cell 110N.

The battery servicing station 102 may be used for manufacturing, processing and testing of electric vehicle (EV) batteries. In an implementation, the battery servicing station 102 may be a mobile electric vehicle battery servicing station arranged in a vehicle. In such implementation scenario, the battery servicing station 102 may be taken to a work site for testing and repair of EV batteries and battery triage as well. In another implementation, the battery servicing station 102 may be a fixed station located at a fixed place. In such implementation scenario, the EV batteries requiring testing and repair are brought to the battery servicing station 102.

The battery servicing system 104 may include suitable logic, circuitry, interfaces, or code that is configured for use in the battery servicing station 102. The battery servicing system 104 may be configured for containment of a malfunction battery and transport the malfunction battery to a remote area with minimum human intervention. Alternatively stated, the battery servicing system 104 may be configured for testing of any hazardous material and transportation of the hazardous material outside the battery servicing station 102. The term “servicing” includes picking an EV battery from an electric vehicle, or another remote location, automatically performing battery triage operations (e.g., one or more tests and advanced diagnostics and characterization with a view to repair the EV battery), performing repair of the EV battery where possible, and automatically and safely ejecting and transporting the malfunctioned battery.

In an implementation, the electric vehicle 106 may arrive at the battery servicing station 102. Alternatively, the battery servicing station 102 may be mobile, for example, the battery servicing station 102, may be implemented in a vehicle that allows remote servicing of EV batteries as per need. The electric vehicle 106 may require testing of the battery pack 108. The battery pack 108 corresponds to an electric vehicle battery pack. The battery servicing system 104 is configured to test the battery pack 108. The testing of the battery pack 108 is described in detail, for example, in FIG. 1B. In a case where an anomaly or an adverse event is identified in one or more cells, for example, the first cell 110A and the second cell 110B, in the battery pack 108, it may be estimated whether repair is feasible or a replacement of the identified cells is feasible, and which may be a better option given cost parameter. In a case where replacement is estimated to be a better option, the battery servicing system 104 is configured to replace the one or more cells that are identified with the anomaly or the adverse event. In another case, if the anomaly or the adverse event is identified for a large number of cells, and it is estimated that it may be better to discard the battery pack 108, the battery servicing system 104 is configured to perform automatic ejection of the battery pack 108 for safe disposal. Additionally, the battery servicing system 104 provides safe transportation of the battery pack 108 from the battery servicing station 102 without requiring human intervention.

FIG. 1B is a block diagram that illustrates various exemplary components of a battery servicing system, in accordance with an embodiment of the present disclosure. FIG. 1B is described in conjunction with elements from FIG. 1A. With reference to FIG. 1B, there is shown a block diagram 100B of the battery servicing system 104 that includes an isolation unit 112 comprising a container part 114 and a lid 116. The lid 116 may also be referred to as a test plate or a work plate disposed on a workstation in the battery servicing station 102 (FIG. 1A). In an implementation, the lid 116 may be a flat platform where a battery to be tested can be placed. The isolation unit 112 is connected to a frame 118 coupled to an electronic winch 120. The battery servicing system 104 further includes a plurality of actuators 122, such as a first actuator 122A, a second actuator 122B, a third actuator 122C and up to a Nth actuator 122N, and a controller 124. The battery servicing system 104 optionally includes an off-grid energy storage system 126, a plurality of sensors 128, a link harness 130, a communication interface 132, a memory 134, a disconnecting sensor 136, and a retraction unit 138, depending on an application scenario.

The isolation unit 112 may be configured for containment of a malfunction battery, for example, the battery pack 108, in case a large number of cells of the battery pack 108 are tested as malfunctioned. The isolation unit 112 may be of any shape, for example, a square box, a rectangular box, a container that is complementary to the shape of a battery pack, and the like. The isolation unit 112 may also be referred to as a burnout container or a burnout box.

Each actuator from the plurality of actuators 122 may include suitable logic, circuitry, interfaces, or code that is configured to receive a signal or instruction from the controller 124 and convert the signal or instruction into a mechanical action, for example, generate a motion to move a given item as instructed by the controller 124. Examples of the plurality of actuators 122 may include but are not limited to, a robotic equipment, a robotic arm, an electro-mechanical mover, an assembly machine, a part of a machine, an electric motor, a pneumatic actuator, a hydraulic cylinder, a screw jack, and the like.

The controller 124 may include suitable logic, circuitry, interfaces, or code that is configured to control the plurality of actuators 122 to position a battery (e.g., the battery pack 108) being tested on the lid 116 that is configured as test plate and disposed on a workstation inside the battery servicing station 102. Examples of the controller 124 may include, but are not limited to, a processor, a co-processor, a microprocessor, a microcontroller, a complex instruction set computing (CISC) processor, an application-specific integrated circuit (ASIC) processor, a reduced instruction set (RISC) processor, a very long instruction word (VLIW) processor, a central processing unit (CPU), a state machine, a data processing unit, and other processors or circuits. Moreover, the controller 124 may refer to one or more individual processors, processing devices, a processing unit that is part of a machine.

The off-grid energy storage system 126 may include suitable logic, circuitry, interfaces, or code that is configured to supply power to the battery servicing system 104 for various operations. In case of any event of power disruption, the battery servicing system 104 is automatically switched to the off-grid energy storage system 126. For example, the off-grid energy storage system 126 may be a solar system.

The plurality of sensors 128 may include suitable logic, circuitry, interfaces, or code that is configured to perform battery triage and repair at the battery servicing system 104. Each of the plurality of sensors 128 may also be referred to as a sensing device or a sensing unit. Examples of the plurality of sensors 128 may include, but are not limited to, a position sensor, a pressure sensor, a temperature sensor, a vibration sensor, a fluid property sensor, a force sensor, and the like.

The link harness 130 may include suitable logic, circuitry, interfaces, or code that is configured to connect a fluid line and an electrical connection line to the battery (i.e., the battery pack 108). Moreover, the link harness 130 may also be used to disconnect the fluid line and the electrical connection line from the battery (i.e., the battery pack 108) by just a pulling action of the link harness 130.

The communication interface 132 may include suitable logic, circuitry, interfaces, or code that is configured to communicate with the controller 124. Examples of the communication interface 132 may include, but are not limited to, a radio frequency transceiver, a network interface, a telematics unit, an antenna, and the like. The communication interface 132 may wirelessly communicate by use of various wireless communication protocols.

The memory 134 may include suitable logic, circuitry, interfaces, or code that is configured to store machine code and/or instructions executable by the controller 124. Examples of implementation of the memory 134 may include, but are not limited to, an Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer readable storage medium, and/or CPU cache memory. The memory 134 may store an operating system and/or a computer program product to operate the battery servicing system 104. A computer readable storage medium for providing a non-transient memory may include, but is not limited to, an electronic storage device, a magnetic storage device, an optical storage device, an electromagnetic storage device, a semiconductor storage device, or any suitable combination of the foregoing.

The disconnecting sensor 136 may include suitable logic, circuitry, interfaces, or code that is configured to allow a signal to be sent to the controller 124 to confirm the operation of the automatic ejection of the malfunctioning battery.

The retraction unit 138 may include suitable logic, circuitry, interfaces, or code that is configured to be used in conjunction with the link harness 130 to move the fluid and electrical lines up and away from the malfunctioning battery facilitating auto ejection. The electrical and fluid lines are held in tension when connecting to the battery pack and are automatically retracted once disconnected.

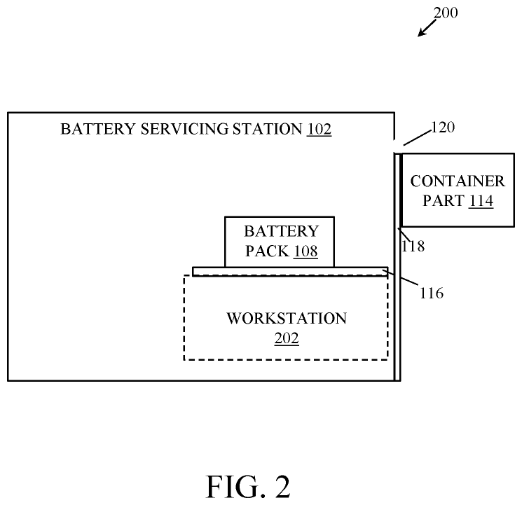

The disclosed is the battery servicing system 104 for use in the battery servicing station 102. The battery servicing station 102 comprises the plurality of actuators 122 and the controller 124. The controller 124 is configured to control the plurality of actuators 122 to position a battery being tested on the lid 116 that is configured as a test plate on a workstation in the battery servicing station 102. In an implementation, the plurality of actuators 122 may be assembled as a robot or a robotic component (e.g., a robotic arm) which is controlled by the controller 124. In another implementation, the plurality of actuators 122 may be assembled as the first actuator 122A, the second actuator 122B, the third actuator 122C and up to the Nth actuator 122N having a unique feature and function. For example, the first actuator 122A, the second actuator 122B, and the third actuator 122C may be used as an electric motor, a screw jack, and a pulley, respectively. The controller 124 is configured to control each of the plurality of actuators 122 in a way to position the battery (e.g., the battery pack 108) which is required to be tested on the lid 116. The lid 116 is configured as the test plate (or a work plate) arranged on the workstation, described in detail, for example, in FIG. 2. Alternatively stated, the battery being tested is positioned on the test plate on the workstation. In an implementation, the battery may be used as the battery pack 108 comprising the plurality of cells 110 (of FIG. 1A). In another implementation, the battery may be used as a single EV battery.

The controller 124 is further configured to test the battery based on a predefined set of reference parameters. The controller 124 is configured to test each of the plurality of cells 110 (e.g., the first cell 110A, the second cell 110B, and up to the Nth cell 110N) of the battery (i.e., the battery pack 108) on the basis of the predefined set of reference parameters. The battery (i.e., the battery pack 108) is said to be a malfunctioning battery when a defined set of battery parameters (e.g., temperature, voltage and current values, and the like) deviate from the predefined set of reference parameters. Alternatively stated, the battery (i.e., the battery pack 108) is determined as the malfunctioning battery on detection of an anomaly or an adverse event in the battery (i.e., the battery pack 108).

The controller 124 is further configured to automatically eject the battery from the battery servicing station 102 when the battery is determined to be malfunctioning. After determining the battery (i.e., the battery pack 108) as malfunctioning, the controller 124 is configured to automatically eject the battery (i.e., the battery pack 108) from the battery servicing station 102 by use of the plurality of actuators 122.

The controller 124 is further configured to drop the container part 114 onto the malfunctioning battery such that the lid 116 and the container part 114 are engaged along with the malfunctioning battery and transported away from the battery servicing station 102. In an implementation, the lid 116 may be implemented and used as the test plate where the battery is placed for testing. The lid 116 may be disposed on the top surface of the workstation 202. In an implementation, the controller 124 may be configured to drop the container part 114 on to the malfunctioning battery (i.e., the battery pack 108) in such a way that the lid 116 and the container part 114 get engaged along with the malfunctioning battery (i.e., the battery pack 108).

After dropping the container part 114 on to the malfunctioning battery (i.e., the battery pack 108), the controller 124 may be further configured to transport the malfunctioning battery (i.e., the battery pack 108) outside the battery servicing station 102 by use of the plurality of actuators 122. In another implementation, the controller 124 may be configured to eject the malfunctioning battery (i.e., the battery pack 108) into the container part 114 in such a way that the lid 116 and the container part 114 get engaged along with the malfunctioning battery (i.e., the battery pack 108). After ejection of the malfunctioning battery (i.e., the battery pack 108) into the container part 114, the controller 124 may be configured to transport or drop the container part 114 outside the battery servicing station 102 by use of the plurality of actuators 122 (e.g., a robotic arm may be instructed to drop the container part 114 automatically).

In an implementation, the ejection of the malfunctioning battery comprises sensing a placement and an orientation of the malfunctioning battery with respect to an opening of the container part 114 and where the container part 114 when engaged with the lid 116 constitute the isolation unit 112 for containment of the malfunctioning battery. The sensing of the placement and the orientation of the malfunctioning battery (i.e., the battery pack 108) with respect to the opening of the container part 114 leads to a more accurate dropping of the container part 114 on to the malfunctioning battery (i.e., the battery pack 108). After dropping of the container part 114 onto the malfunctioning battery (i.e., the battery pack 108), the container part 114 gets engaged with the lid 116 in such a way that the isolation unit 112 is constituted for containment of the malfunctioning battery (i.e., the battery pack 108). In an implementation, the isolation unit 112 is made of a metal, or a metal alloy configured for containment of the malfunctioning battery. For example, the isolation unit 112 may be made up of steel or an alloy metal. Therefore, the isolation unit 112 may also be referred to as a steel burnout box which is configured for containment of the malfunctioning battery (i.e., the battery pack 108).

In an implementation, the ejection of the malfunctioning battery further comprises generating an alert for an operator present in the battery servicing station 102 when the battery being tested is determined to be malfunctioning. In a case, when the battery (i.e., the battery pack 108) is detected as malfunctioning, the controller 124 is configured to generate the alarm of ejection of the malfunctioning battery (i.e., the battery pack 108) for the operator currently working into the battery servicing station 102.

In an implementation, the ejection of the malfunctioning battery is automatically performed on completion of a defined threshold time when an input is not detected from the operator within the defined threshold time. In case of generation of the alarm for the operator currently working into the battery servicing station 102, the controller 124 is configured to wait for the input from the operator up to the defined threshold time. If the controller 124 does not receive the input from the operator within the defined threshold time, the controller 124 is configured to automatically eject the malfunctioning battery (i.e., the battery pack 108) upon completion of the defined threshold time.

In an implementation, the ejection of the malfunctioning battery further comprises disconnecting one or more physical connections from the battery in the battery servicing station 102, where the one or more physical connections comprises one or more of: a power cord plugged into the battery being tested, one or more fluid connections with the battery being tested, and one or more other connections for sensing a defined set of battery parameters of the battery being tested. Before ejection of the malfunctioning battery (i.e., the battery pack 108), the controller 124 is configured to disconnect the one or more physical connections of the battery (i.e., the battery pack 108) in the battery servicing station 102. The one or more physical connections of the battery (i.e., the battery pack 108) includes connections to a main power supply through a power cord, connections for sensing the voltage and current parameters of the battery, and the like.

In an implementation, the defined set of battery parameters of the battery comprises: voltage and current parameters, an amount of heat generated while being charged, a fluid leakage, a charge-discharge rate, and a status of health (SoH) parameters. The voltage and current parameters define the voltage and current values at which the battery pack 108 can be charged or discharged with safety. During charging of the battery pack 108, the amount of heat generated from the battery pack 108. But in a case, if the amount of heat generated becomes greater than the predefined reference value, the required safety actions should be taken care to avoid any damage. Similarly, the fluid leakage, the charge-discharge rate and the SoH parameters of each of the plurality of cells 110 of the battery pack 108 are compared with the predefined reference values, respectively. In case of any deviation of aforementioned battery parameters from the predefined reference values, safety actions should be taken care of. Depending on SoH parameters of each of the plurality of cells 110 of the battery pack 108, the battery pack 108 may be repaired and reused in an electric vehicle. In a case, if SoH parameters of the plurality of cells 110 of the battery pack 108 drop below automotive SoH standards, then in such a case, the battery pack 108 may be used for non-automotive applications. Moreover, the plurality of cells 110 which cannot be reused for any of aforementioned applications, may be recycled.

In an implementation, the battery servicing system 104 further comprises the frame 118 coupled with the electronic winch 120, where the container part 114 is disposed outside the battery servicing station 102 via the frame 118 coupled with the electronic winch 120. By using the frame 118 coupled with the electronic winch 120, the controller 124 may be configured to dispose the container part 114 outside the battery servicing station 102. Generally, the electronic winch 120 is a pulley device used for lifting heavy components, such as the malfunctioning battery (i.e., the battery pack 108) by rotating a cable that is attached to a fixture used for holding the cable and move the container part 114 outside the battery servicing station 102. The electronic winch 120 may also be referred to as a hoist.

In an implementation, the battery servicing system 104 further comprises the off-grid energy storage system 126, where operations of the battery servicing system 104 are powered by the off-grid energy storage system 126 or automatically switched to the off-grid energy storage system 126 from a mains supply in an event of a power disruption. The operations of the battery servicing system 104, such as testing of the battery as the malfunctioning battery (i.e., the battery pack 108), the automatic ejection of the malfunctioning battery (i.e., the battery pack 108), and dropping the container part 114 onto the malfunctioning battery (i.e., the battery pack 108) outside the battery servicing station 102 are powered by the off-grid energy storage system 126. The off-grid energy storage system 126 may also be configured to store the charge of the malfunctioning battery (i.e., the battery pack 108) during its discharging. Also, the stored charge may also be further used for charging of a new battery (or a battery pack) that is to be used in place of the malfunctioning battery (i.e., the battery pack 108).

In an implementation, the battery servicing system 104 further comprises the plurality of sensors 128, and where the controller 124 is further configured to perform battery triage and repair by use of the plurality of sensors 128 and the plurality of actuators 122 at the battery servicing system 104. The plurality of sensors 128 and the plurality of actuators 122 are collectively used for battery triage and battery repair at the battery servicing system 104. For example, each of the plurality of sensors 128 may be used to determine whether the SoH parameters of the malfunctioning battery (i.e., the battery pack 108) are above or below the automotive SoH standards. In a case, if the SoH parameters of the malfunctioning battery (i.e., the battery pack 108) are above the automotive SoH standards then, in such a case, the malfunctioning battery (i.e., the battery pack 108) may be repaired and reused in the electric vehicle. In another case, if the SoH parameters of the malfunctioning battery (i.e., the battery pack 108) are below the automotive SoH standards then, in such a case, the malfunctioning battery (i.e., the battery pack 108) may be used for non-automotive applications. Also, the plurality of actuators 122 may be configured to replace the malfunctioning battery (i.e., the battery pack 108) with a new battery (or a new battery pack).

In an implementation, the battery servicing station 102 is an off-grid mobile electric vehicle battery servicing station arranged in a vehicle, and where the container part 114 is arranged outside the vehicle. In an implementation, the battery servicing station 102 may be used as the off-grid mobile electric vehicle battery servicing station arranged in the vehicle. In such implementation scenario, the battery servicing station 102 may be taken to a work site for testing and repair of EV batteries and battery triage as well.

Thus, the battery servicing system 104 enables an efficient transportation of the malfunctioned battery (i.e., the battery pack 108) outside the battery servicing station 102. Moreover, the battery servicing system 104 enables an automated ejection of the malfunctioned battery (i.e., the battery pack 108) and transport the container part 114 along with the malfunctioned battery (i.e., the battery pack 108) away from the battery servicing station 102. Due to automatic ejection of the malfunctioned battery (i.e., the battery pack 108) outside the battery servicing station 102, no lifting equipment and human intervention is required for transportation of the malfunctioned battery. This further enables a removal of operators from hazardous operations as well as provides time for personnel to be safely evacuated as soon as any safety issue arises at the battery servicing station 102. This further reduces the risk of any damage to the battery servicing station 102 as well as any harm to the life of operators working at the battery servicing station 102. The battery servicing system 104 may also be configured for use in automotive centres, original equipment manufacturers (OEMs), dealer networks, test houses, other design houses, car fleet providers, vehicle auction houses, battery OEMs, and the like.

FIG. 2 illustrates dropping of a container part onto a malfunctioning battery outside a battery servicing station, in accordance with an embodiment of the present disclosure. FIG. 2 is described in conjunction with elements from FIGS. 1A and 1B. With reference to FIG. 2, there is shown an illustration 200 that depicts dropping of the container part 114 onto the malfunctioning battery (i.e., the battery pack 108) outside the battery servicing station 102 (of FIG. 1A). There is further shown a workstation 202 on which the malfunctioning battery (i.e., the battery pack 108) is positioned.

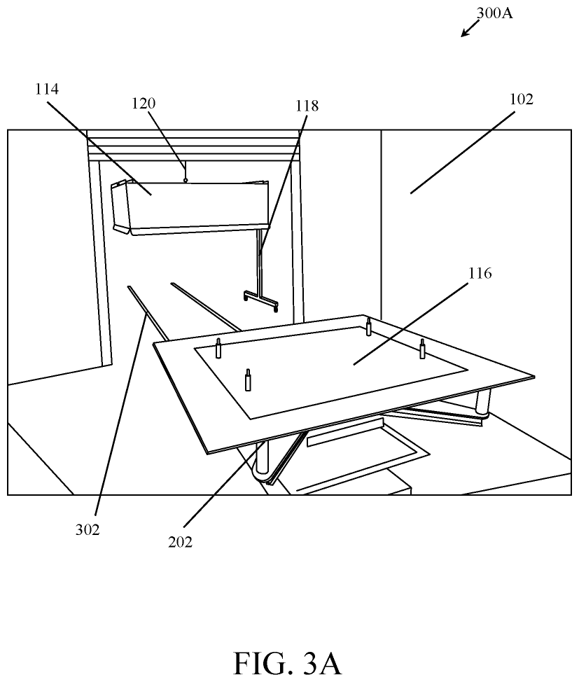

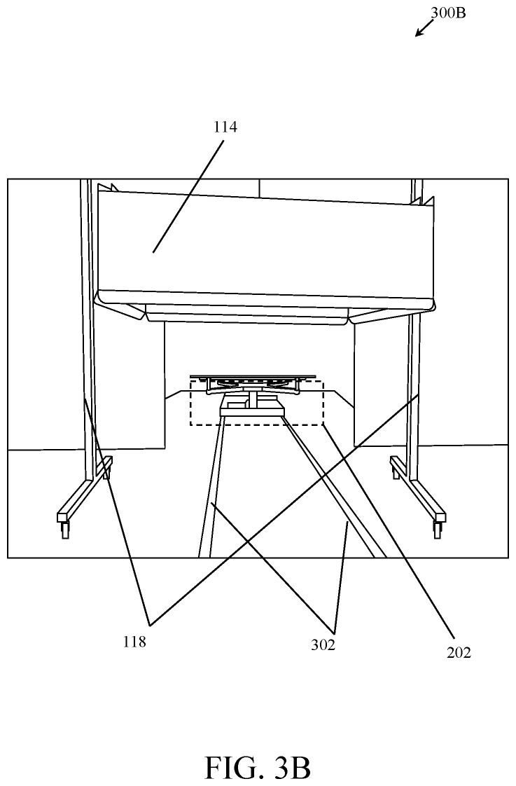

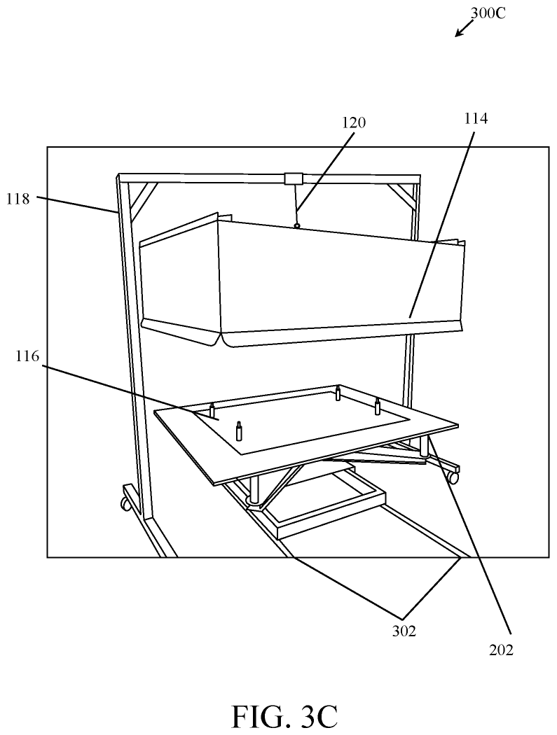

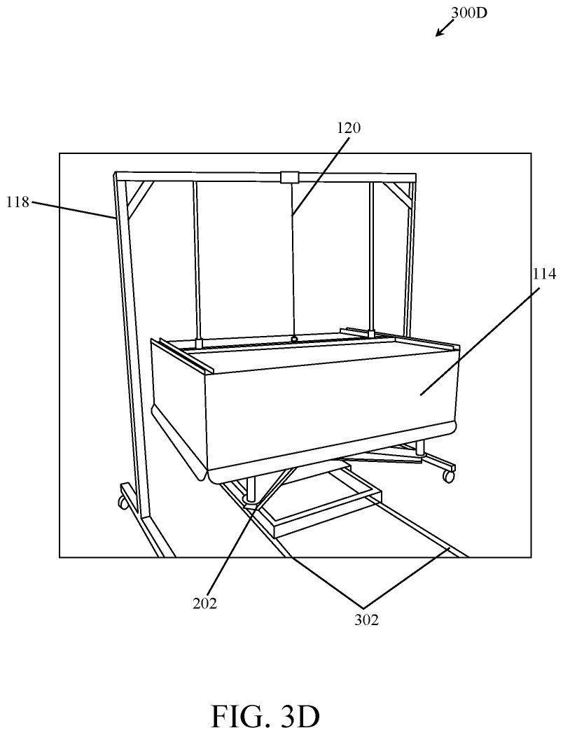

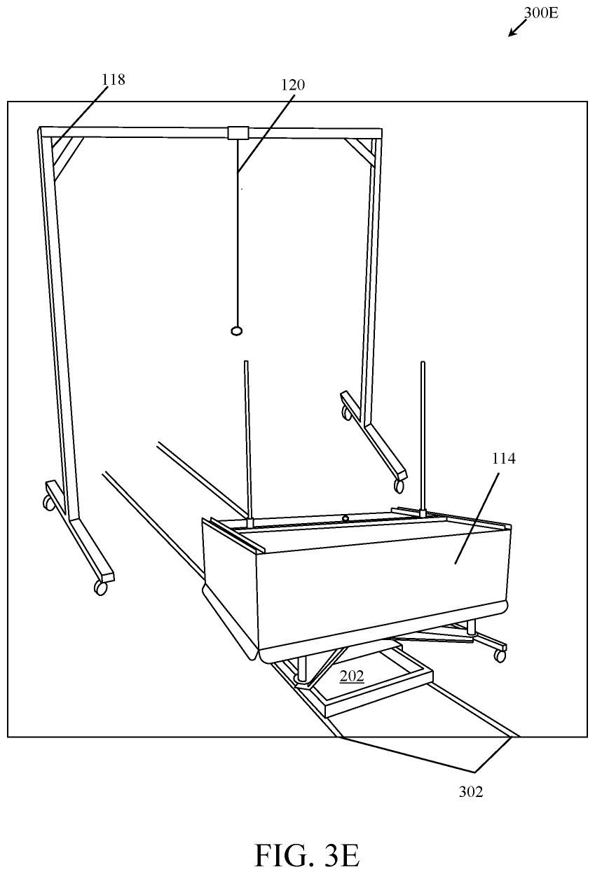

In an implementation, one or more actuators of the plurality of actuators 122 are provided in the workstation 202 in the battery servicing station 102, and where the ejection of the malfunctioning battery further comprises moving the workstation 202 carrying the malfunctioning battery over a defined track outside the battery servicing station 102 by controlling the one or more actuators. The malfunctioning battery (i.e., the battery pack 108) positioned on the lid 116 by use of the one or more actuators of the plurality of actuators 122. The lid 116 configured as the test plate is further arranged on the workstation 202. The workstation 202 may also be referred to as a self-propelling workstation. The workstation 202 can be moved inside the battery servicing station 102 as well as outside the battery servicing station 102 over the defined track (e.g., a railway track), described in detail, for example, in FIGS. 3A-3E. The workstation 202 carrying the malfunctioning battery (i.e., the battery pack 108) is moved from inside of the battery servicing station 102 to the outside of the battery servicing station 102 over the defined track by use of the one or more actuators of the plurality of actuators 122. After moving the workstation 202 along with the malfunctioning battery (i.e., the battery pack 108) outside the battery servicing station 102, the container part 114 is dropped over the workstation 202 for containment of the malfunctioning battery (i.e., the battery pack 108), described in detail, for example, in FIGS. 3C-3E. In an implementation, the container part 114 may be dropped over the lid 116 of the workstation 202 for containment of the malfunctioning battery (i.e., the battery pack 108). In another implementation, the container part 114 may be dropped over the workstation 202 for containment of the malfunctioning battery (i.e., the battery pack 108).

In an implementation, the ejection of the malfunctioning battery further comprises orientating the workstation 202 to trigger a movement of the malfunctioning battery such that the malfunctioning battery is contained in the container part 114. The ejection of the malfunctioning battery (i.e., the battery pack 108) includes orientating the workstation 202 in such a way that the malfunctioning battery is contained into the container part 114. Moreover, the container part 114 is arranged outside the battery servicing station 102 using the frame 118 coupled with the electronic winch 120.

FIG. 3A illustrates an exemplary arrangement of a workstation and a container part of a battery servicing system at a battery servicing station, in accordance with an embodiment of the present disclosure. FIG. 3A is described in conjunction with elements from FIGS. 1A, 1B, and 2. With reference to FIG. 3A, there is shown a first scenario 300A that illustrates an arrangement of the workstation 202 (of FIG. 2) and the container part 114 of the battery servicing system 104 (of FIG. 1B) at the battery servicing station 102. There is further shown a defined track 302 on which the workstation 202 can be moved inside and outside of the battery servicing station 102.

As shown in FIG. 3A, the lid 116 configured as the test plate is arranged on the workstation 202 (i.e., the self-propelling workstation). The battery (not shown) that is to be tested is positioned on the lid 116, which is used as a test plate and disposed on the workstation 202. The workstation 202 lies inside the battery servicing station 102 before and during testing of the battery (e.g., a battery pack). The container part 114 of the battery servicing system 104 is disposed outside the battery servicing station 102 via the frame 118 coupled with the electronic winch 120. After determination of the battery as the malfunctioning battery, the workstation 202 along with the malfunctioning battery arranged on the lid 116 can be moved outside the battery servicing station 102, where the workstation 202 moves on the defined track 302. In this case, the defined track 302 is a rail track. However, it is to be understood by one of ordinary skill in the art that the defined track 302 may be any defined path pre-set to facilitate auto ejection of the malfunctioning battery along the defined path, for example, by use of channels, conveyor, a robot, an electronic carrier, and the like.

FIG. 3B illustrates an arrangement of a container part of a battery servicing system at a battery servicing station, in accordance with an embodiment of the present disclosure. FIG. 3B is described in conjunction with elements from FIGS. 1A, 1B, 2, and 3A. With reference to FIG. 3B, there is shown a second scenario 300B that illustrates an arrangement of the container part 114 of the battery servicing system 104 (of FIG. 1B) outside the battery servicing station 102.

The container part 114 of the battery servicing system 104 is disposed (i.e., arranged) outside the battery servicing station 102 by use of the frame 118. The frame 118 is coupled with the electronic winch 120 (e.g., a hoist), shown in detail, for example, in FIG. 3A. Moreover, the defined track 302 lies inside as well as outside the battery servicing station 102. The workstation 202 lies inside the battery servicing station 102 over the defined track 302.

FIG. 3C illustrates an arrangement of a workstation and a container part of a battery servicing system outside a battery servicing station, in accordance with an embodiment of the present disclosure. FIG. 3C is described in conjunction with elements from FIGS. 1A, 1B, 2, 3A, and 3B. With reference to FIG. 3C, there is shown a third scenario 300C that illustrates an arrangement of the workstation 202 and the container part 114 of the battery servicing system 104 outside the battery servicing station 102 after auto ejection of the malfunctioning battery. The malfunctioning battery (e.g., the battery pack 108) is not shown in the FIG. 3C.

In case of determination of the battery as the malfunctioning battery (i.e., the battery pack 108) arranged on the lid 116 of the workstation 202, the workstation 202 is moved along with the malfunctioning battery (i.e., the battery pack 108) outside of the battery servicing station 102 by use of the defined track 302. The workstation 202 is moved in such a way that the workstation 202 along with the malfunctioning battery (i.e., the battery pack 108) lies beneath the container part 114 of the battery servicing system 104.

FIG. 3D illustrates dropping of a container part onto a malfunctioning battery outside a battery servicing station, in accordance with another embodiment of the present disclosure. FIG. 3D is described in conjunction with elements from FIGS. 1A, 1B, 2, 3A, 3B, and 3C. With reference to FIG. 3D, there is shown a fourth scenario 300D that depicts dropping of the container part 114 onto the malfunctioning battery (not shown here) outside the battery servicing station 102 (of FIG. 1A). The container part 114 is dropped over the workstation 202 (i.e., dropped over malfunctioning battery when placed on the lid 116 configured as the test plate on the workstation 202) in such a way that the lid 116 and the container part 114 are engaged along with the malfunctioning battery and further is transported away from the battery servicing station 102 for safe disposal without any human intervention.

FIG. 3E illustrates movement of a container part along with a malfunctioning battery outside a battery servicing station, in accordance with an embodiment of the present disclosure. FIG. 3E is described in conjunction with elements from FIGS. 1A, 1B, 2, 3A, 3B, 3C, and 3D. With reference to FIG. 3E, there is shown an illustration 300E that depicts a further movement of the container part 114 along with the malfunctioning battery (i.e., the battery pack 108) outside the battery servicing station 102 (of FIG. 1A).

The container part 114 along with the malfunctioning battery (i.e., the battery pack 108) is moved away from the battery servicing station 102 over the defined track 302. After movement of the container part 114 along with the malfunctioning battery away from the battery servicing station 102, the container part 114 is detached from the frame 118 coupled with the electronic winch 120. In an implementation, the container part 114 when engaged with the lid 116 forms as isolation unit (such as the isolation unit 112) for containment of the malfunctioning battery.

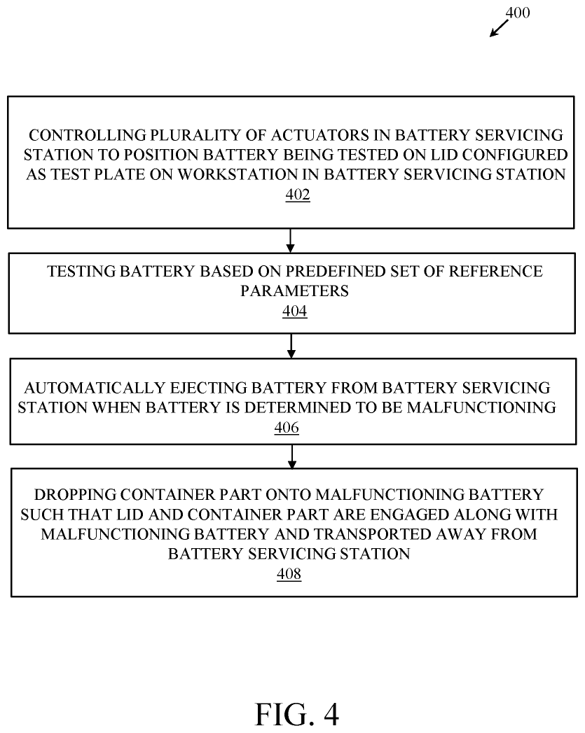

FIG. 4 is a flowchart of a method for servicing a battery, in accordance with an embodiment of the present disclosure. FIG. 4 is described in conjunction with elements from FIGS. 1A, 1B, 2, and 3A-3E. With reference to FIG. 4, there is shown a method 400 that includes steps 402 to 408. The battery servicing system 104 (of FIGS. 1A and 1B) is configured to execute the method 400.

The method 400 is provided for servicing the battery (e.g., the battery pack 108 of FIG. 1A). The method 400 includes testing of the battery, determination of the battery as the malfunctioning battery and disposing the malfunctioning battery outside the battery servicing station 102 without human intervention. The method 400 is described in detail, in following steps.

At step 402, the method 400 comprises controlling the plurality of actuators 122 in the battery servicing station 102 to position the battery (e.g., the battery pack 108) being tested on the lid 116 configured as a test plate on the workstation 202 in the battery servicing station 102. The battery (i.e., the battery pack 108) that is required to be tested is positioned on the lid 116 by controlling the plurality of actuators 122. The lid 116 is configured as the test plate (or work plate) on the workstation 202 in the battery servicing station 102. The plurality of actuators 122 are controlled by the controller 124 (of FIG. 1B). Furthermore, the container part 114 is arranged outside the battery servicing station 102 using the frame 118 coupled with the electronic winch 120, described in detail, for example, in FIGS. 3A-3E.

At step 404, the method 400 further comprises testing the battery (i.e., the battery pack 108) based on a predefined set of reference parameters. Various parameters of the battery (i.e., the battery pack 108), such as voltage and current parameters, the amount of heat generated during charging of the battery (i.e., the battery pack 108), the charge-discharge rate, the SoH parameters, and the like, are compared with the predefined set of reference parameters.

At step 406, the method 400 further comprises automatically ejecting the battery (i.e., the battery pack 108) from the battery servicing station 102 when the battery (i.e., the battery pack 108) is determined to be malfunctioning. In case of any deviation of aforementioned battery parameters with respect to the predefined set of reference parameters, the battery (i.e., the battery pack 108) is determined as the malfunctioning battery. In the present disclosure, the battery (i.e., the battery pack 108) is determined as the malfunctioning battery. In order to avoid any damage at the battery servicing station 102, the malfunctioning battery (i.e., the battery pack 108) is automatically ejected outside the battery servicing station 102.

At step 408, the method 400 further comprises dropping the container part 114 onto the malfunctioning battery such that the lid 116 and the container part 114 are engaged along with the malfunctioning battery (i.e., the battery pack 108) and transported away from the battery servicing station 102. The workstation 202 along with the malfunctioning battery is moved outside the battery servicing station 102 where the container part 114 is arranged by use of the frame 118 coupled with the electronic winch 120. Thereafter, the container part 114 is dropped over the workstation 202 in such a way that the lid 116 and the container part 114 get engaged with the malfunctioning battery. The container part 114 along with the malfunctioning battery is transported away from the battery servicing station 102.

In an implementation, the ejecting of the malfunctioning battery (i.e., the battery pack 108) comprises sensing a placement and an orientation of the malfunctioning battery (i.e., the battery pack 108) with respect to an opening of the container part 114 disposed outside the battery servicing station 102, and where the container part 114 when engaged with the lid 116 configured as the test plate constitute the isolation unit 112 for containment of the malfunctioning battery. Before ejecting the malfunctioning battery (i.e., the battery pack 108), the placement and orientation of the malfunctioning battery (i.e., the battery pack 108) is aligned according to the opening of the container part 114, in order to safely eject the malfunctioning battery (i.e., the battery pack 108) outside the battery servicing station 102, have been described in detail, for example, in FIG. 1B.

In an implementation, the ejecting of the malfunctioning battery further comprises moving the workstation 202 carrying the malfunctioning battery over the defined track 302 outside the battery servicing station 102. In order to eject the malfunctioning battery (i.e., the battery pack 108) outside the battery servicing station 102, the workstation 202 carrying the malfunctioning battery is moved outside the battery servicing station 102 over the defined track 302 by use of one or more actuators of the plurality of actuators 122.

The steps 402 to 408 are only illustrative and other alternatives can also be provided where one or more steps are added, one or more steps are removed, or one or more steps are provided in a different sequence without departing from the scope of the claims herein.

In one aspect, a computer program product is provided for performing the method 400 when executed by one or more controllers (e.g., the controller 124 of the battery servicing system 104) in a computer system. In another aspect, a computer system is provided comprising one or more controllers (e.g., the controller 124) and one or more memories (e.g., the memory 134), storing program instructions which, when executed by the one or more controllers (i.e., the controller 124), cause the one or more controllers (i.e., the controller 124) to execute the method 400. In yet another aspect, the present disclosure provides a non-transitory computer-readable medium having stored thereon, computer-implemented instructions that, when executed by a computer, causes the computer to execute operations of the method 400.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

1. A battery servicing system for use in a battery servicing station comprising:
a plurality of actuators; and
a controller configured to:
control the plurality of actuators to position a battery being tested on a lid that is configured as a test plate on a workstation in the battery servicing station;
test the battery based on a predefined set of reference parameters;
automatically eject the battery from the battery servicing station when the battery is determined to be malfunctioning; and
drop a container part onto the malfunctioning battery such that the lid and the container part are engaged along with the malfunctioning battery and transported away from the battery servicing station.

2. The battery servicing system of claim 1, wherein the ejection of the malfunctioning battery comprises sensing a placement and an orientation of the malfunctioning battery with respect to an opening of the container part, and wherein the container pair when engaged with the lid constitute an isolation unit for containment of the malfunctioning battery.

3. The battery servicing system of claim 1, or wherein the ejection of the malfunctioning battery further comprises generating an alert for an operator present in the battery servicing station when the battery being tested is determined to be malfunctioning.

4. The battery servicing system of claim 3, wherein the ejection of the malfunctioning battery is automatically performed on completion of a defined threshold time when an input is not detected from the operator within the defined threshold time.

5. The battery servicing system of claim 1, wherein the ejection of the malfunctioning battery further comprises disconnecting one or more physical connections from the battery in the battery servicing station wherein the one or more physical connections comprises one or more of: a power cord plugged into the battery being tested, one or more fluid connections with the battery being tested, and one or more other connections for sensing a defined set of battery parameters of the battery being tested.

6. The battery servicing system of claim 5, wherein the defined set of battery parameters of the battery comprises: voltage and current parameters, an amount of heat generated while being charged, a fluid leakage, a charge-discharge rate, and a status of health, SoH, parameters.

7. The battery servicing system of claim 1, further comprising a frame coupled with an electronic winch wherein the container part is disposed outside the battery servicing station via the frame coupled with the electronic winch.

8. The battery servicing system of claim 1, wherein one or more actuators of the plurality of actuators are provided in a-the workstation in the battery servicing station and wherein the ejection of the malfunctioning battery further comprises moving the workstation carrying the malfunctioning battery over a defined track outside the battery servicing station by controlling the one or more actuators.

9. The battery servicing system of claim 8, wherein the ejection of the malfunctioning battery further comprises orientating the workstation to trigger a movement of the malfunctioning battery such that the malfunctioning battery is contained in the container part.

10. The battery servicing system of claim 1, further comprising an off-grid energy storage system wherein operations of the battery servicing system are powered by the off-grid energy storage system or automatically switched to the off-grid energy storage system from a mains supply in an event of a power disruption.

11. The battery servicing system of claim 1, further comprising a plurality of sensors, and wherein the controller is further configured to perform battery triage and repair by use of the plurality of sensors and the plurality of actuators at the battery servicing system.

12. The battery servicing system of claim 1, wherein the battery servicing station is an off-grid mobile electric vehicle battery servicing station arranged in a vehicle, and wherein the container part is arranged outside the vehicle.

13. A method for servicing a battery, comprising:
controlling a plurality of actuators in a battery servicing station to position a battery being tested on a lid configured as a test plate on a workstation in the battery servicing station
testing the battery based on a predefined set of reference parameters;
automatically ejecting the battery from the battery servicing station when the battery is determined to be malfunctioning; and
dropping a container part onto the malfunctioning battery such that the lid and the container part are engaged along with the malfunctioning battery and transported away from the battery servicing station

14. The method of claim 13, wherein the ejecting of the malfunctioning battery comprises sensing a placement and an orientation of the malfunctioning battery with respect to an opening of the container part disposed outside the battery servicing station and wherein the container pair when engaged with the lid configured as the test plate constitute an isolation unit for containment of the malfunctioning battery.

15. The method claim 13, or wherein the ejecting of the malfunctioning battery further comprises moving the workstation carrying the malfunctioning battery over a defined track outside the battery servicing station.
